(19) United States
(12) Patent Application Publication
(10) Pub. No.: US 2009/0279178 A1
(43) Pub. Date: Nov. 12, 2009

(54) Scanhead For Image Illumination Uniformity And Method Thereof

(76) Inventor: Chengwu Cui, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/117,834

(22) Filed: May 9, 2008

(51) Int. Cl. G02B 27/00

(52) U.S. Cl. 359/613; 359/601

(57) ABSTRACT

A scanhead of an imaging apparatus for providing image illumination uniformity for imaging of a media sheet, and a method thereof, are disclosed. The scanhead includes a lens, a lens shading plate and a sensor array. The lens is capable of receiving light reflected from the media sheet and focusing the received light. The lens shading plate is capable of assuming a lens shading plate position of a plurality of lens shading plate positions between the lens and the sensor array for receiving the light focused by the lens. The lens shading plate, on assuming the lens shading plate position, is capable of adjusting the light received from the lens for focusing the light onto the sensor array, thereby providing image illumination uniformity, for the imaging of the media sheet.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Disclosure

The present disclosure relates generally to imaging apparatuses, and, more particularly, to a scanhead of an imaging apparatus for providing image illumination uniformity for imaging of a media sheet.

2. Description of the Related Art

Imaging apparatuses, such as scanners, are widely used in offices, in homes and in business enterprises. An imaging apparatus scans an object, such as a media sheet, and converts it into a digital image. In a platen glass configuration of the imaging apparatus, the media sheet is, typically, placed on a transparent platen, such as a glass surface, for imaging purposes, and an opaque shield is placed over the media sheet for excluding surrounding light from impinging on the media sheet. A light source may be provided below the transparent platen for directing light at the media sheet for illuminating the media sheet. A mirror assembly captures the light reflected from the illuminated media sheet and deflects the light reflected from the illuminated media sheet towards a lens for focusing the light onto a sensor system. The sensor system receives the light focused by the lens and images the media sheet, i.e., converts the light received from the lens into the digital image. In the platen glass configuration, the media sheet is stationery and a scanning assembly including the light source, the mirror assembly, the lens and the sensor system, scans across the media sheet for scanning the media sheet. The imaging apparatus may also be configured to employ an automatic document feeder instead of the aforementioned platen glass configuration. In such a configuration, employing the automatic document feeder, the scanning assembly is parked to a window across which the media sheet traverses, for scanning the media sheet.

Both scan configurations, i.e., the platen glass configuration and the configuration employing the automatic document feeder, typically, use a wide angle lens and multiple folding mirrors in the mirror assembly for configuring a compact and a cost-effective imaging apparatus. However, a field angle, i.e., an angle at which light is received at an imaging surface of the sensor system (also referred to as an imaging plane) is relatively large for such a compact imaging apparatus. The relatively large field angle may result in a vignette effect, i.e., reduction of an illumination received at the imaging plane by a factor proportional to fourth power of a cosine of the angle at which the light impinges on the sensor system. The vignette effect may be expressed as cos⁴ θ effect, where θ is the field angle. Thus, the vignette effect results in reduced illumination at a peripheral region of the imaging plane, as compared to the illumination at a central region of the imaging plane. For instance, if the media sheet being imaged is a white sheet of paper, then the white sheet of paper may appear to be significantly darker at an edge portion than a central portion of the white sheet of paper.

Referring now to drawings and more specifically to FIG. 1, an exemplary graphical plot 10 illustrating the vignette effect on illumination received at the imaging plane is depicted. Graphical plot 10 includes a curve 12 representing a variation in illumination (of a media sheet) received at an imaging plane with a corresponding variation in the field angle, for a uniform light source illumination. The variation in the field angle, measured in degrees, is depicted on a horizontal axis of graphical plot 10 and the variation in the illumination, measured as a percentage reduction in received illumination at the imaging plane (measured from an optical axis of the lens), is depicted on a vertical axis of graphical plot 10. As evident from curve 12, the illumination received at the imaging plane lacks uniformity across the imaging plane, and more specifically, the illumination is substantially reduced at an edge portion of the imaging plane as compared to a central portion of the imaging plane. Thus, the cos⁴ θ effect creates uneven, i.e., non-uniform image illumination at the imaging plane. Non-uniform image illumination at the imaging plane may result in poor imaging quality for imaging of the media sheet.

Moreover, the non-uniform image illumination at the imaging plane is a combined effect of the vignette effect as well as a non-uniform light source, i.e., a light source characterized by an asymmetrical illumination output distribution. If a light source is uniform, the non-uniform image illumination at the imaging plane is solely contributed by the cos⁴ θ effect (as depicted in FIG. 1). However, with typical light sources, the illumination may not be consistent and, as such, may vary from one light source to another. Moreover, the illumination of the light sources may vary both in total illumination output as well as in the distribution of the total illumination output.

FIG. 2 depicts an exemplary graphical plot 20 illustrating the combined effect of the vignette effect and the non-uniform light source on the illumination received at the imaging plane. Graphical plot 20 includes a curve 22 representing a variation in illumination (of the media sheet) received at the imaging plane with a corresponding variation in the field angle, for a non-uniform light source illumination. The variation in the field angle, measured in degrees, is depicted on a horizontal axis of graphical plot 20 and the variation in illumination, measured as a percentage reduction in received illumination at the imaging plane (measured from an optical axis of the lens), is depicted on a vertical axis of graphical plot 20. Curve 22, illustrates the combined effect of the vignette effect as well as the effect of the non-uniform light source on the illumination received at the imaging plane. As evident from curve 22, the illumination received at the imaging plane is non-uniform across the imaging plane and may substantially degrade the imaging quality for imaging the media sheet.

Compensating for non-uniform image illumination at the imaging plane using specialized software may be fairly complex and, as such, may not provide desired uniformity in image illumination. Typically, non-uniform image illumination at the imaging plane may be corrected by selectively blocking light impinging on the central portion of the imaging plane by shading either at the light source, or, at the lens. Shading at the lens is usually achieved with a lens shading plate configured with a special shaped aperture and disposed near the lens. Such a lens shading plate is typically disposed at a fixed position in the imaging apparatus and, as such, is not capable of adapting to variation in design of imaging apparatuses as well as adapting to different light sources provided in the imaging apparatus.

Based on the foregoing, there is a need for providing image illumination uniformity at the imaging plane for imaging of a media sheet. Further, there exists a need for compensating for the vignette effect on the image illumination uniformity at the imaging plane for imaging the media sheet. Furthermore, there exists a need for compensating for the effect of non-uniform light sources on the image illumination uniformity at the imaging plane for imaging of the media sheet.

### SUMMARY OF THE DISCLOSURE

In view of the foregoing disadvantages inherent in the prior art, the general purpose of the present disclosure is to provide a scanhead of an imaging apparatus for providing image illumination uniformity and a method thereof to include all the advantages of the prior art, and to overcome the drawbacks inherent therein.

In one aspect, the present disclosure provides a scanhead of an imaging apparatus for providing image illumination uniformity for imaging of a media sheet. The scanhead includes a lens, a lens shading plate and a sensor array. The lens is capable of receiving light reflected from the media sheet and focusing the received light. The lens shading plate is capable of assuming a lens shading plate position of a plurality of lens shading plate positions between the lens and the sensor array for receiving the light focused by the lens. The lens shading plate, on assuming the lens shading plate position, is capable of adjusting the light received from the lens for focusing the light onto the sensor array, thereby providing image illumination uniformity for the imaging of the media sheet.

In another aspect, the present disclosure provides a method for providing image illumination uniformity for imaging of a media sheet. The imaging apparatus comprises a lens capable of focusing light onto a sensor array. The media sheet is illuminated by a light source and the light reflected from the media sheet is deflected onto a lens. A lens shading plate is disposed at a lens shading plate position of a plurality of lens shading plate positions between the lens and the sensor array, such that the lens shading plate receives light focused by the lens and focuses the light onto the sensor array. The lens shading plate disposed at the lens shading plate position is capable of adjusting the light focused from the lens onto the sensor array for providing image illumination uniformity for the imaging of the media sheet.

In another aspect, the present disclosure provides a lens shading plate of the scanhead. The lens shading plate comprises a shading correction region and an adjusting mechanism. The shading correction region is capable of providing a shading correction to the light focused from the lens onto the sensor array. The adjusting mechanism is capable of adjusting the shading correction region to assume the lens shading plate position of the plurality of lens shading plate positions between the lens and the sensor array for receiving the light focused by the lens. The shading correction by the shading correction region to the light received from the lens adjusts the light focused from the lens onto the sensor array for providing the image illumination uniformity for the imaging of the media sheet.

The adjustment to the light provided by the shading correction region compensates for the vignette effect as well as the effect of the variation in light source illumination on the image illumination uniformity at the imaging plane for the imaging of the media sheet. Furthermore, the adjusting mechanism of the lens shading plate enables the lens shading plate to assume the lens shading plate position for optimally placing the shading correction region for adjusting the light focused from the lens onto the sensor array. Adjusting the light focused from the lens onto the sensor array provides image illumination uniformity for the imaging of the media sheet.

### BRIEF DESCRIPTION OF THE DRAWINGS

The above-mentioned and other features and advantages of the present disclosure, and the manner of attaining them, will become more apparent and the present disclosure will be better understood by reference to the following description of embodiments of the present disclosure taken in conjunction with the accompanying drawings, wherein:

FIG. 1 is an exemplary graphical plot illustrating a vignette effect on image illumination received at the imaging plane;

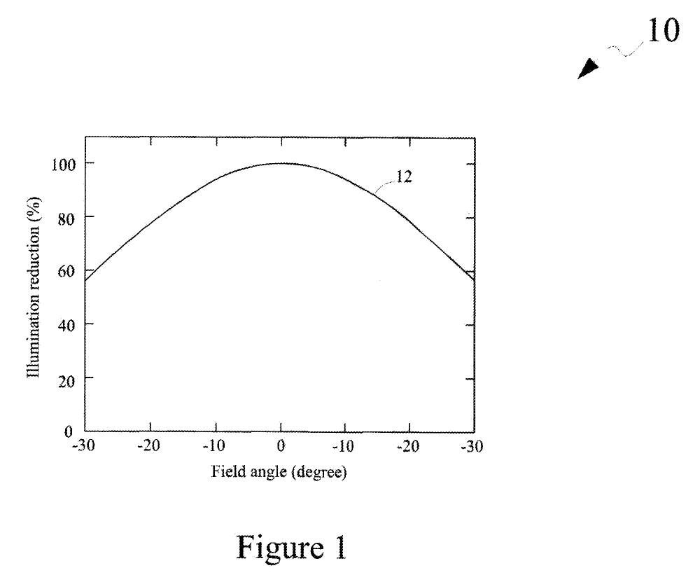

FIG. 2 depicts an exemplary graphical plot illustrating a combined effect of the vignette effect and a non-uniform light source on image illumination received at the imaging plane;

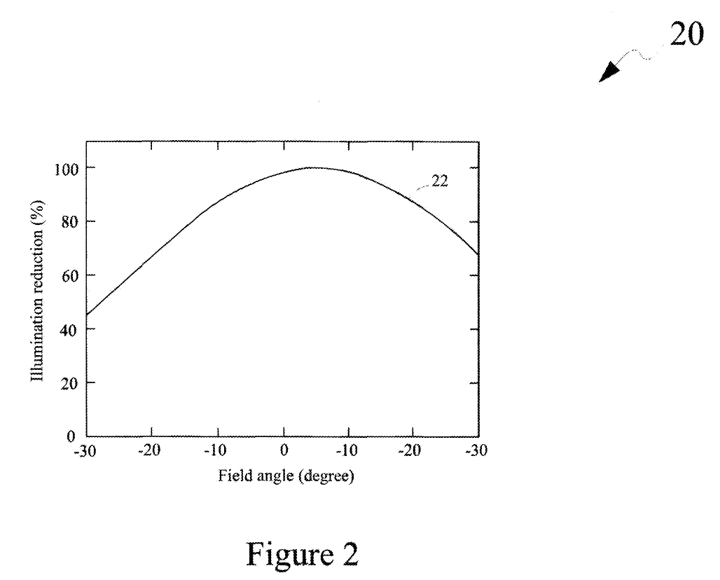

FIG. 3 is a schematic depiction of a cross sectional view of a scanhead for imaging of a media sheet in an imaging apparatus embodying the present disclosure;

FIG. 4 is a schematic depiction of a lens shading plate of the scanhead of the imaging apparatus embodying the present disclosure; and

FIG. 5 is an exemplary graphical plot illustrating lens shading plate corrected illumination received at the imaging plane embodying the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

In addition, it should be understood that embodiments of the present disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the present disclosure may be implemented in software. As such, it should be noted that a plurality of hardware and software-based devices, as well as a plurality of different structural components may be utilized to implement the present disclosure. Furthermore, and as described in subsequent paragraphs, the specific mechanical configurations illustrated in the drawings are intended to exemplify embodiments of the present disclosure and that other alternative mechanical configurations are possible.

The present disclosure provides a scanhead of an imaging apparatus for providing image illumination uniformity for imaging of a media sheet and a method thereof. The scanhead includes a lens, a lens shading plate and a sensor array. The lens is capable of receiving light reflected from the media sheet and focusing the received light. The lens shading plate is capable of assuming a lens shading plate position of a plurality of lens shading plate positions between the lens and the sensor array for receiving the light focused by the lens. The lens shading plate, on assuming the lens shading plate position, is capable of adjusting the light received from the lens for focusing the light onto the sensor array, thereby providing image illumination uniformity, for the imaging of the media sheet.

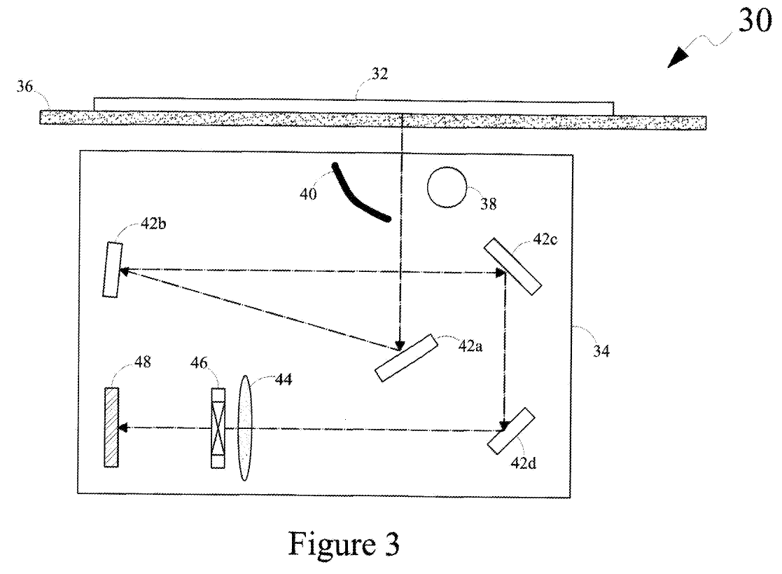

Referring now to FIG. 3, there is shown a schematic depiction of a cross sectional view of a scanhead 34 for imaging of a media sheet 32 in an imaging apparatus 30 embodying the present disclosure. Further, description of FIG. 3, also describes a method for providing image illumination uniformity for the imaging of media sheet 32.

Imaging apparatus 30 includes scanhead 34 and a transparent platen 36. It will be apparent to those skilled in the art that imaging apparatus 30 is shown for exemplary purposes and that imaging apparatus 30 may include components other than scanhead 34 and transparent platen 36. Transparent platen 36 includes a first surface (not shown) for placing media sheet 32. Scanhead 34 includes a light source 38, a reflecting unit 40, a plurality of mirrors such as a mirror 42a, a mirror 42b, a mirror 42c and a mirror 42d, a lens 44, a lens shading plate 46 and a sensor array 48. The plurality of mirrors such as mirror 42a, mirror 42b, mirror 42c and mirror 42d will hereinafter be collectively referred to as plurality of mirrors 42 (not shown). It will be obvious to a person skilled in the art that scanhead 34 may be moved relative to media sheet 32 such as in a flatbed platen glass configuration, or, media sheet 32 may be moved relative to scanhead 34 such as in an automatic media sheet feeding configuration for the imaging of media sheet 32. Further, scanhead 34 may image a single scan line or multiple scan lines in one horizontal sweep across media sheet 32 for the imaging of media sheet 32.

Light source 38 may be capable of providing light for illuminating media sheet 32. Light from light source 38 may be directed at reflecting unit 40 for reflecting the light towards media sheet 32 through transparent platen 36 for illuminating media sheet 32. An example of light source 38 may include but is not limited to an external electrode xenon fluorescent lamp. Transparent platen 36 may be any transparent surface, such as a glass surface, and the like. The light reflected from media sheet 32 may be received by at least one mirror of plurality of mirrors 42 for deflecting the light onto lens 44. In one embodiment of the present disclosure, the light reflected from media sheet 32 is received by mirror 42a and deflected towards mirror 42b. Mirror 42b receives the light deflected by mirror 42a and further deflects the received light towards mirror 42c. Furthermore, mirror 42c receives the light deflected by mirror 42c and deflects the received light towards mirror 42d. Thereafter, mirror 42d deflects the received light towards lens 44.

Accordingly, lens 44 is capable of receiving light reflected from media sheet 32 and deflected using at least one mirror of plurality of mirrors 42 for focusing the received light onto sensor array 48. Lens shading plate 46 receives light focused by lens 44 and directs the focused light onto sensor array 48. Lens shading plate 46 is capable of assuming a plurality of lens shading plate positions between lens 44 and sensor array 48. Prior to the imaging of media sheet 32, lens shading plate 46 may be disposed at a lens shading plate position of the plurality of lens shading plate positions for adjusting the light focused by lens 44 onto sensor array 48. Lens shading plate 46 disposed at the lens shading plate position for adjusting the light focused by lens 44 onto sensor array 48 provides image illumination uniformity for the imaging of media sheet 32. It will be evident to a person skilled in the art that the lens shading plate position between lens 44 and sensor array 48 implies a region in vicinity of an exit window of lens 44, i.e., a plane where equivalent light limit aperture is outside of lens 44. The region may typically be near an aperture of lens 44.

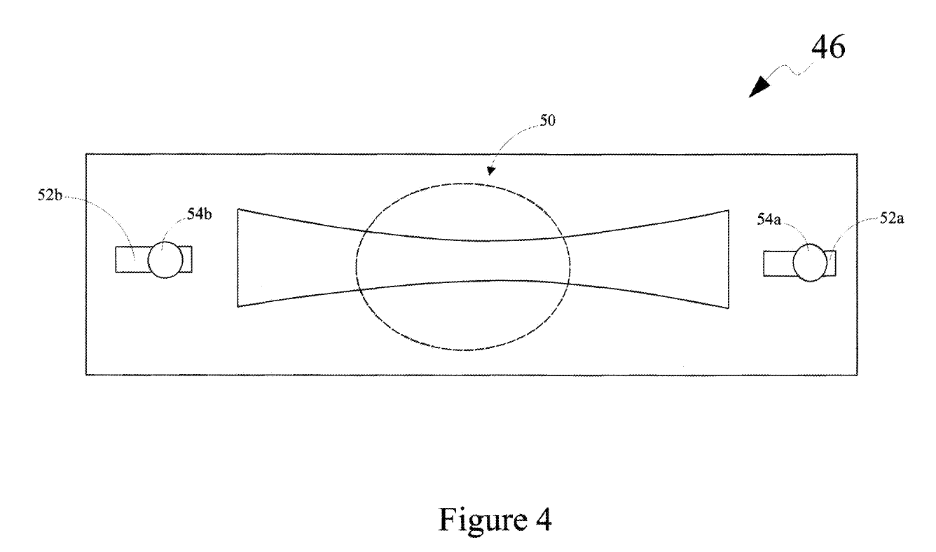

Lens shading plate 46, thus, provides correction to the light to be focused onto sensor array 48 for providing image illumination uniformity at the imaging plane, i.e., an imaging surface at sensor array 48. Sensor array 48 may receive the light focused by lens 44 through lens shading plate 46 and then convert the light to a digital image for the imaging of media sheet 32. Lens shading plate 46 for providing image illumination uniformity for the imaging of media sheet 32 is explained in detail in conjunction with FIG. 4.

FIG. 4 depicts lens shading plate 46 of scanhead 34 embodying the present disclosure. Lens shading plate 46 includes a shading correction region 50 and an adjusting mechanism. As explained in conjunction with FIG. 3, lens shading plate 46 is disposed between lens 44 and sensor array 48 at the lens shading plate position of the plurality of lens shading plate positions. Shading correction region 50 of lens shading plate 46 is capable of providing shading correction to the light focused by lens 44 onto sensor array 48. It will be obvious to those skilled in the art that providing shading correction to the light focused by lens 44 onto sensor array 48 may include adjusting the light such that the light uniformly impinges onto sensor array 48. In one embodiment of the present disclosure, adjusting the light may further include blocking the light and/or selectively enabling the light to pass at edges of lens shading plate 46 as compared to a central portion of lens shading plate 46 for impinging onto sensor array 48.

The shading correction may be provided to compensate for a vignette effect, (also referred to as the cos⁴ θ effect) for providing uniform image illumination at the imaging plane for the imaging of media sheet 32. The vignette effect is associated with reduced illumination at a peripheral region of the imaging plane. The shading correction provided by shading correction region 50 may adjust the light to uniformly impinge onto sensor array 48, thereby providing image illumination uniformity at the imaging plane for the imaging of media sheet 32.

In one embodiment of the present disclosure, adjusting mechanism includes at least one mounting hole such as a mounting hole 52a and a mounting hole 52b for adjusting shading correction region 50 to assume the lens shading plate position of the plurality of lens shading plate position and for receiving the light focused by lens 44 onto sensor array 48. The mounting holes, such as mounting hole 52a and mounting hole 52b, will hereinafter be collectively referred to as mounting holes 52. Each of mounting holes 52 extends in a horizontal position to enable shading correction region 50 to slide and assume the lens shading plate position. It will be obvious to a person skilled in the art that lens shading plate 46 may slide along at least one mounting hole of mounting holes 52 to assume the lens shading plate position of the plurality of lens shading plate positions. Herein, lens shading plate 46 in the lens shading plate position refers to shading correction region in the lens shading plate position for receiving the light focused by lens 44 onto sensor array 48. Mounting holes 52 may be used to dispose lens shading plate 46 over support elements, such as support element 54a and support element 54b (provided in scanhead 34), for enabling lens shading plate 46 to slide along mounting hole 52a and mounting hole 52b respectively, for assuming the lens shading plate position.

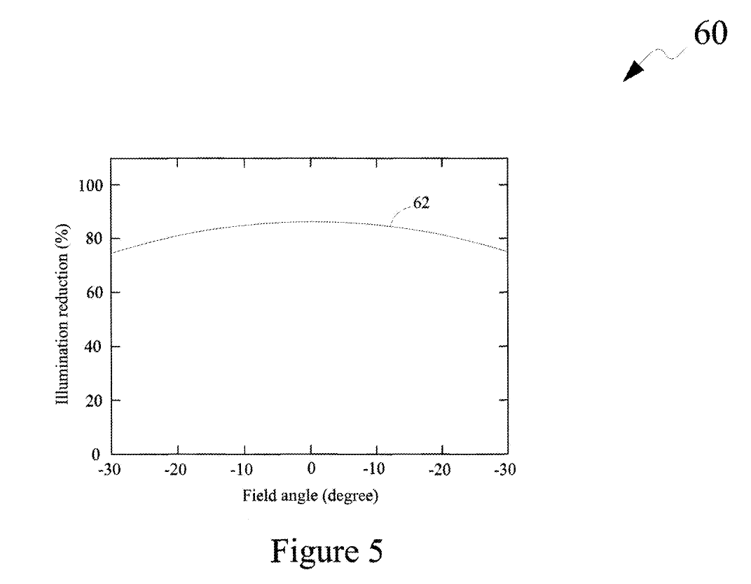

In another embodiment of the present disclosure, adjusting mechanism may include known in the art mechanical configurations for sliding shading correction region 50, horizontally, for assuming the lens shading plate position. For example, adjusting mechanism may include a slot for sliding shading correction region 50 to assume the lens shading plate position. Adjusting mechanism enables shading correction region 50 to be optimally placed, such that, shading correction region 50 may appropriately adjust the light received from lens 44 for correcting the vignette effect as well as non-uniform light source illumination that may be provided by light source 38. Thus, image illumination uniformity for the imaging of media sheet 32 may be provided by scanhead 34. An exemplary graphical plot illustrating the illumination received at the imaging plane using lens shading plate 46 is depicted in FIG. 5.

FIG. 5 depicts an exemplary graphical plot 60 illustrating a lens shading plate corrected illumination received at an imaging plane, embodying the present disclosure. Graphical plot 60 includes a curve 62 representing a variation in the illumination received at the imaging plane with a corresponding variation in a field angle, i.e., an angle at which light impinges at the imaging plane. The variation in the field angle, measured in degrees, is depicted on a horizontal axis of graphical plot 60 and the variation in illumination is depicted on a vertical axis of graphical plot 60 and is measured as a percentage reduction in received illumination at the imaging plane (measured from an optical axis of lens 44). As can be seen from curve 62, the illumination received at the imaging plane is substantially uniform across the imaging plane. The vignette effect associated with the loss of illumination at the peripheral region of the imaging plane is also substantially corrected, and, moreover, curve 62 is substantially uniform over the imaging plane, thereby providing uniform image illumination at the imaging plane for the imaging of media sheet 32.

Scanhead 34 as provided herein including lens shading plate 46 is capable of assuming a plurality of lens shading plate positions for adjusting the light focused from lens 44 onto sensor array 48 for providing uniform image illumination uniformity for imaging media sheet 32. Based on a type of lens 44 chosen and characteristics of light source 38, lens shading plate 46 may be accordingly disposed at a lens shading plate position of the plurality of lens shading plate positions between lens 44 and sensor array 48 to optimally place shading correction region 50 to receive the light from lens 44 and provide shading correction for compensating for the vignette effect on the image illumination uniformity at the imaging plane for imaging media sheet 32. Further, based on the variation in the illumination output of light source 38, the lens shading plate position of lens shading plate 46 may accordingly be determined to compensate for the effect of variation in the light source illumination on the image illumination uniformity at the imaging plane for imaging media sheet 32. Furthermore, adjusting mechanism of lens shading plate provides lens shading plate 46 capability to adapt to non-uniform image illumination for providing image illumination uniformity for the imaging of media sheet 32.

The foregoing description of several methods and an embodiment of the present disclosure have been presented for purposes of illustration. It is not intended to be exhaustive or to limit the present disclosure to the precise steps and/or forms disclosed, and obviously many modifications and variations are possible in light of the above description. It is intended that the scope of the present disclosure be defined by the claims appended hereto.

What is claimed is:

1. A scanhead of an imaging apparatus for providing image illumination uniformity for imaging of a media sheet, the scanhead comprising:
a lens capable of receiving light reflected from the media sheet, the lens configured to focus the light received from the media sheet;
a lens shading plate capable of receiving the light focused by the lens, the lens shading plate capable of assuming a lens shading plate position of a plurality of lens shading plate positions for receiving the light focused by the lens; and
a sensor array capable of receiving the light from the lens shading plate for the imaging of the media sheet,
wherein the lens shading plate is disposed between the lens and the sensor array, and, wherein the lens shading plate is capable of assuming the lens shading plate position of the plurality of lens shading plate positions to adjust the light focused from the lens onto the sensor array for providing the image illumination uniformity for the imaging of the media sheet.

2. The scanhead of claim 1 wherein the lens shading plate comprises:
a shading correction region capable of providing a shading correction to the light focused from the lens onto the sensor array; and
an adjusting mechanism for adjusting the shading correction region to assume the lens shading plate position for receiving the light focused by the lens, the shading correction to the light received from the lens by the shading correction region adjusting the light focused from the lens onto the sensor array for providing the image illumination uniformity for the imaging of the media sheet.

3. The scanhead of claim 2 wherein the adjusting mechanism comprises at least one mounting hole capable of enabling the shading correction region to slide along the at least one mounting hole for assuming the lens shading plate position.

4. The scanhead of claim 1 further comprising a light source capable of illuminating the media sheet for reflecting the light from the media sheet.

5. The scanhead of claim 4 further comprising at least one mirror capable of deflecting the light reflected from the media sheet onto the lens.

6. A lens shading plate of a scanhead of an imaging apparatus for providing image illumination uniformity for imaging of a media sheet, the scanhead comprising a lens capable of focusing light onto a sensor array, the lens shading plate comprising:
a shading correction region capable of providing a shading correction to the light focused from the lens onto the sensor array; and
an adjusting mechanism for adjusting the shading correction region to assume a lens shading plate position of the plurality of lens shading plate positions for receiving the light focused by the lens, the plurality of lens shading plate positions between the lens and the sensor array,
wherein the shading correction by the shading correction region to the light received from the lens adjusts the light focused from the lens onto the sensor array for providing the image illumination uniformity for the imaging of the media sheet.

7. The lens shading plate of claim 6 wherein the adjusting mechanism comprises at least one mounting hole capable of enabling the shading correction region to slide along the at least one mounting hole for assuming the lens shading plate position.

8. A method for providing image illumination uniformity for imaging of a media sheet in an imaging apparatus, the imaging apparatus comprising a lens capable of focusing light onto a sensor array, the method comprising:
illuminating the media sheet by a light source;
deflecting light reflected from the media sheet onto a lens, the light reflected from the media sheet on illumination of the media sheet;
disposing a lens shading plate between the lens and the sensor array at a lens shading plate position of a plurality of lens shading plate positions, the lens shading plate receiving the light from the lens; and
focusing light from the lens shading plate onto the sensor array for the imaging of the media sheet,
wherein the lens shading plate disposed at the lens shading plate position is capable of adjusting the light focused from the lens onto the sensor array for providing image illumination uniformity for the imaging of the media sheet.

9. The method of claim 8 wherein deflecting light reflected from the media sheet onto the lens comprises reflecting the light reflected from the media sheet by at least one mirror onto the lens.

10. The method of claim 8 wherein disposing the lens shading plate at the lens shading plate position comprises sliding the lens shading plate along at least one mounting hole configured in the lens shading plate to assume the lens shading plate position.
